(19) United States
(12) Patent Application Publication
(10) Pub. No.: US 2009/0287848 A1
(43) Pub. Date: Nov. 19, 2009

(54) INFORMATION PROCESSING DEVICE AND COMMUNICATION CONTROL METHOD

(75) Inventors: Koichiro Kamura, Fujisawa-shi (JP); Tsutomu Rockuhara, Tama-shi (JP); Hiroshi Nakajima, Nishitokyo-shi (JP); Akihiro Nonoyama, Komae-shi (JP); Tatsuya Kurozumi, Hachioji-shi (JP); Arata Ando, Nishitokyo-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki kaisha Toshiba, Tokyo (JP)

(21) Appl. No.: 12/351,442

(22) Filed: Jan. 9, 2009

(30) Foreign Application Priority Data
May 13, 2008 (JP) 2008-126080

(51) Int. Cl. G06F 15/16

(52) U.S. Cl. 709/246

(57) ABSTRACT

According to one embodiment, the host virtual machine includes a virtual bridge connection module configure to virtually connect one guest virtual machine and the network by bridge connection, a conversion modules configure to convert packets transmitted from the another guest virtual machines and the application to packets of a virtual private network (VPN) protocol, and a packet allocation module configure to detect a destination of the packets received from the network, to allocate the received packets to the virtual bridge connection module in a case where the detected destination is the one guest virtual machine, and to convert the packets of the VPN protocol received from the network to original packets and to allocate the converted packets to the detected destination in a case where the detected destination is any of the N−1 guest virtual machines and the application that runs on the host virtual machine.

### CROSS-REFERENCE TO RELATED APPLICATIONS

This application is based upon and claims the benefit of priority from Japanese Patent Application No. 2008-126080, filed May 13, 2008, the entire contents of which are incorporated herein by reference.

### BACKGROUND

1. Field

One embodiment of the invention relates to an information processing device and a communication control method in which a plurality of virtual machines are executed simultaneously.

2. Description of the Related Art

In a conventional virtual machine technique, when a plurality of virtual machines are connected to an external network, any one of modes of bridge connection, NAT connection and router connection is set for a physical network interface (a LAN card and the like) used for external connection. Then, software is used to emulate a virtual network.

Jpn. Pat. Appln. Publication No. 2007-110240 (Abstract, Paragraphs 0014 and 0015, and FIG. 1) discloses an information processing device which is divided into a plurality of logic partitions (LPAR), and an OS runs in each LPAR independently from the others. An IP address is used in common in all LPARs, and a representative LPAR performs external communication in place of other LPARs.

However, in the case where the above information processing device is used in a manner that a plurality of virtual machines execute on the same personal computer, one of the virtual machines is operated as a normal personal computer that is generally used, and the other virtual machines run a service and an application that use a network, a problem as described below has occurred.

Bridge connection: a large number of public IP addresses are required

In the case where N guest virtual machines and one host virtual machine are executed on one computer, and these virtual machines are all required to be connected to an external network, N+1 public IP addresses need to be allocated to the computer. In order to execute the guest virtual machines, the host computer normally needs to be operated all the time. For this reason, at least two public IP addresses need to be allocated to the computer.

NAT connection: restriction on applications

This is a system in which one public IP address is allocated to the host virtual machine and private IP addresses are allocated to N guest virtual machines (by the host virtual machine). However, a problem of NAT traversal is generated, and access from the outside where there is no correspondence table of private IPs and protocols in a NAT table is blocked. Accordingly, in comparison with a normal computer, there is much restriction on applications that can be used in the guest virtual machines.

Router connection: complex address management of network

In this system, the host virtual machine works as a router. There is restriction that a network application used in the guest virtual machine needs to be one that supports router traversal. In addition, network address modules of IP addresses that are used by the guest virtual machine and the host virtual machine are different. Address management of a network, such as setting and updating of a routing table of the host computer becomes complex.

For the above reasons, when a plurality of virtual machines are executed on one computer, one of the virtual machines is operated as a normal personal computer, and the other virtual machines run a service and an application using a network, the following has been required:

1. Bridge connection mode is set by bearing consumption of IP addresses; and

2. Network interfaces in two systems are constructed in a system, and a plurality of physical network cards are mounted on a computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a physical configuration of an information processing system including an information processing device according to an embodiment of the present invention;

FIG. 2 is an exemplary block diagram showing a configuration of the information processing device according to the embodiment of the present invention;

FIG. 3A and FIG. 3B are exemplary views showing an example of an IP packet passing between a first guest virtual machine and a virtual bridge connection interface and an IP packet passing from a computer supporting an IP packet transmitted by a second guest virtual machine to an in-house LAN, and an example of an IP packet passing between the guest virtual machine and the virtual bridge connection interface and an IP packet passing from a computer supporting an IP packet transmitted by the first guest virtual machine to an in-house LAN;

FIG. 4 is an exemplary flowchart showing steps of processing of a packet received by a physical network interface card; and

FIG. 5 is an exemplary view showing a logical configuration showing a case where the information processing devices shown in FIG. 1 are connected to the same in-house LAN.

### DETAILED DESCRIPTION

Various embodiments according to the invention will be described hereinafter with reference to the accompanying drawings. In general, according to one embodiment of the invention, an information processing device where a host virtual machine and N guest virtual machines are allocated to a plurality of logically divided computing resources and operating systems run in the host virtual machine and the N guest virtual machines concurrently, respectively, and the information processing device is connected to a network by a network interface, wherein the host virtual machine comprises: a virtual bridge connection module configured to virtually connect one guest virtual machine selected from the N guest virtual machines and the network by bridge connection, a conversion modules provided in association with the N−1 guest virtual machines not connected to the network virtually by bridge connection and an application that runs on the host virtual machine, and configure to convert packets transmitted from the N−1 guest virtual machines and the application that runs on the host virtual machine to packets of a virtual private network (VPN) protocol, and a packet allocation module configured to detect a destination of the packets received from the network, to allocate the received packets to the virtual bridge connection module in a case where the detected destination is the one guest virtual machine, and to convert the packets of the VPN protocol received from the network to original packets and to allocate the converted packets to the detected destination in a case where the detected destination is any of the N−1 guest virtual machines and the application that runs on the host virtual machine.

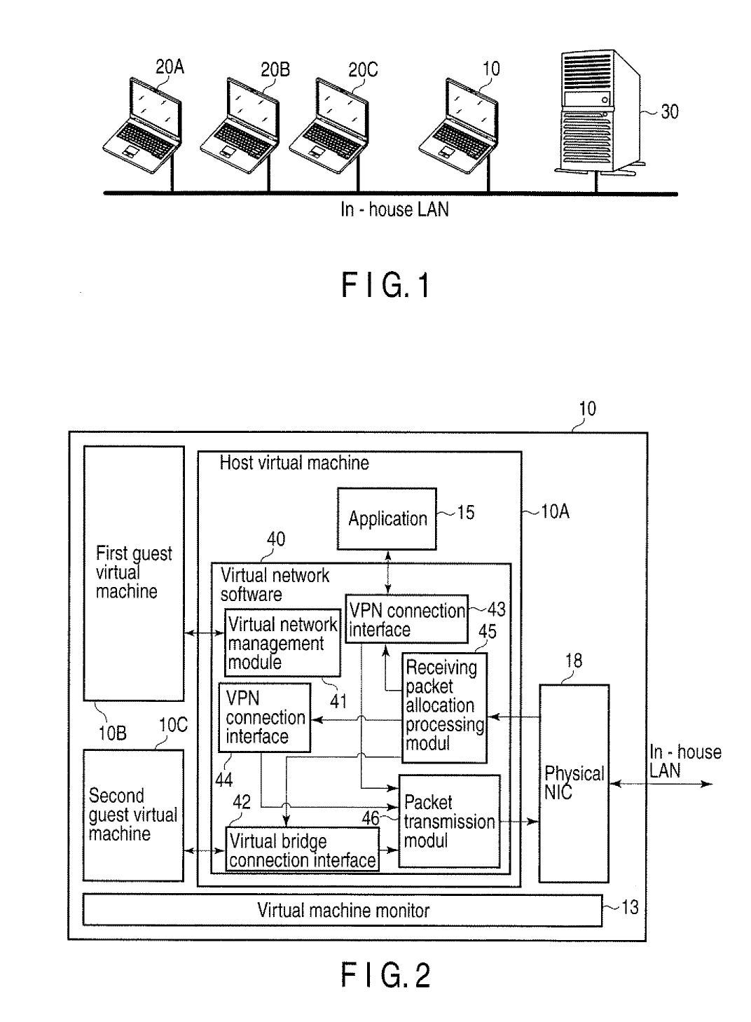

FIG. 1 is a view showing a configuration of an information processing system including a personal computer working as an information processing device according to an embodiment of the present invention.

A computer 10 executes a plurality of virtual machines simultaneously, and realizes the information processing device according to the embodiment of the present invention. In addition, in personal computers 20A to 20C, no virtual machine is executed. The computer 10 and the computers 20A to 20C are connected to an in-house LAN (external network).

Next, description will be made with respect to a configuration of the computer 10 with reference to FIG. 2.

The computer 10 includes computing resources, such as a processor, a RAN, and an I/O device. A virtual machine monitor 13 logically divides the computing resources into plurality of modules, and allocates a host virtual machine 10A, a first guest virtual machine 10B, and a second guest virtual machine 10C to the divided computing resources. The host virtual machine 10A, the first guest virtual machine 10B, and the second guest virtual machine 10C to which the computing resources are allocated execute independently and concurrently. In each of the host virtual machine 10A, the first guest virtual machine 10B, and the second guest virtual machine 10C, an operating system is run.

The computer 10 includes one physical network interface card (NIC) 18 that is used for connecting with an in-house LAN. In the host virtual machine 10A, virtual network software 40 is run. The virtual network software 40 is used for connecting the first guest virtual machine 10B, the second guest virtual machine 10C, and an application 15 running on the host virtual machine 10A with the in-house LAN.

The virtual network software 40 controls the second guest virtual machine 10C among the three virtual machines 10A to 10C to be virtually connected to the in-house LAN by bridge connection, and controls the remaining two virtual machines (the first guest virtual machine 105 and the host virtual machine 10A) to be virtually connected with the in-house LAN by a virtual private network (VPN), on a software basis.

The virtual network software 40 includes a virtual network management module 41, a virtual bridge connection interface 42, a host VPN connection interface 43, a guest VPN connection interface 44, a receiving packet allocation processing module 45, a packet transmission module 46, and the like.

The virtual network management module 41 manages allocation of MAC addresses and IP addresses used by the virtual machines 10A, 10B, and 10C. In addition, the virtual network management module 41 controls the virtual bridge connection interface 42, the host VPN connection interface 43, the guest VPN connection interface 44, the receiving packet allocation processing module 45, and the packet transmission module 46, and the like.

In addition, the virtual network management module 41 has a function of allocating a physical MAC address of a physical network interface card 18 to the second guest virtual machine 10C, and a local MAC addresses to the host virtual machine 10A. Also, the virtual network management module 41 has a function of allocating a public IP address to the second guest virtual machine 10C and local IP addresses to the first guest virtual machine 10B and the host virtual machine 10A. In this manner, the virtual network management module 41 controls the second quest virtual machine 10C to be virtually connected to the network on a network address system by bridge connection, and the first guest virtual machine 10B and the host virtual machine 10A to be virtually connected to the network through a VPN.

The virtual bridge connection interface 42 carries out processing of mediating transmission and reception of packets as if the second guest virtual machine 10C is connected to the in-house LAN by bridge connection. Packets transmitted from the second guest virtual machine 10C to the in-house LAN are sent to the packet transmission module 46 from the virtual bridge connection interface 42.

The host VPN connection interface 43 converts packets transmitted from the application 15 to the in-house LAN to packets of a predetermined VPN protocol, and sends the converted packets to the packet transmission module 46. The guest VPN connection interface 44 carries out processing of converting packets transmitted from the first guest virtual machine 10B to the in-house LAN to packets of a predetermined VPN protocol, and sending the converted packets to the packet transmission module 46.

The packet transmission module 46 carries out processing of transmitting packets to be transmitted to the in-house LAN sent from the virtual bridge connection interface 42, the host VPN connection interface 43, and the guest VPN connection interface 44 to the physical network interface card 18.

The receiving packet allocation processing module 45 analyzes packets received from the physical network interface card 18 to detect packet destinations. Then, the receiving packet allocation processing module 45 carries out processing of allocating the received packets to any of the application 15, the first guest virtual machine 10B, and the second guest virtual machine 10C, depending on the detected destinations.

The virtual network software 40 uses a public IP address used by the second guest virtual machine 10C as an IP header added to a front of packets of the VPN protocol transmitted from the first guest virtual machine 10B and the host virtual machine.

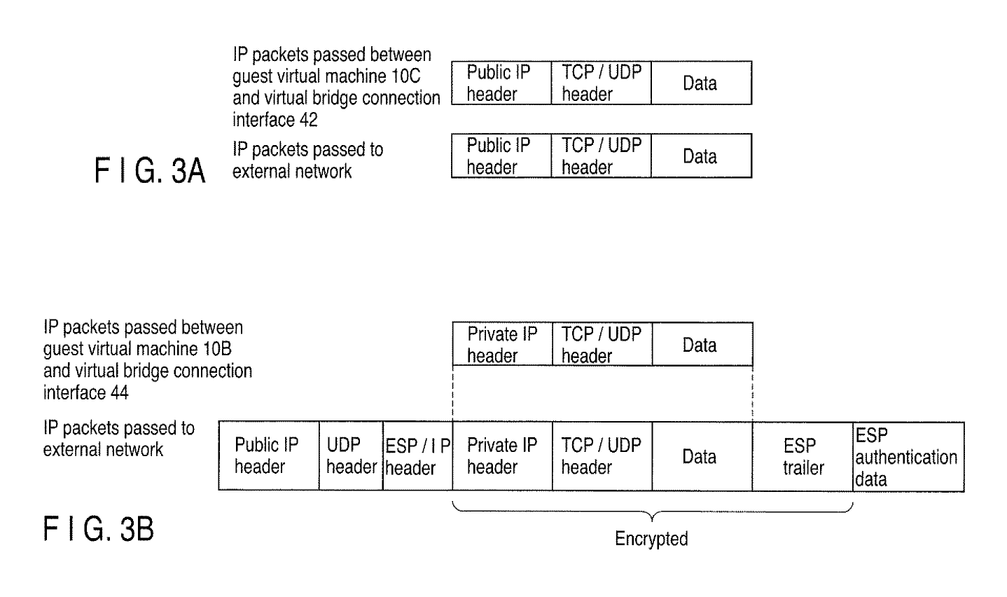

FIG. 3A shows IP packets passed between the second guest virtual machine 10C and the virtual bridge connection interface 42, and IP packets passed from the computer 10 to the in-house LAN. As shown in FIG. 3A, IP packets transmitted from the second guest virtual machine 10C to the virtual bridge connection interface 42 are transmitted to the in-house LAN without change. In addition, in an IP header of the IP packets, a public IP address allocated to the second guest virtual machine 10C by a DHCP server 30 is set as a transmission source.

Hereinafter, description will be made with respect to a method in which the DHCP server 30 allocates an IP address to the second guest virtual machine 10C, and a method that the virtual network management module 41 detects the IP address allocated to the second guest virtual machine 10C by the DHCP server 30.

Allocation of an IP address is carried out by exchange of a DHCP message. A DHCP message is transmitted by a user datagram protocol (UDP). A port number on the DHCP side is 67, and a port number on the second guest virtual machine 10C side is 68.

Hereinafter, a DHCP message used for allocation of an IP address will be described The second guest virtual machine 10C transmits a DHCPDISCOVER packet used for finding the DHCP server 30 to an in-house network. The DHCP server 30 receiving the DHCPDISCOVER packet reserves an IP address that is not in use by an operational computer. Then, the DHCP server 30 transmits and notifies a DHCPOFFER packet including the reserved IP address to a DHCP client of the second guest virtual machine 10C. After receiving the DHCPOFFER packet, the DHCP client transmits a DHCPREQUEST packet to the DHCP server 30 to confirm that the notified IP address is to be used. Then, in the case where the DHCP server 30 receiving the DHCPREQUEST packet agrees to use the notified IP address, the DHCP server 30 returns a DHCPACK packet to the second guest virtual machine 10C.

The virtual network management module 41 monitors the DHCP message to hack the DHCPACK packet, and extracts the IP address allocated to the second guest virtual machine 10C that is included in the packet.

On the other hand, a format of IP packets transmitted from the first guest virtual machine 10B and the host application is converted by using an extension function of an IPsec NAT traversal technique, in which the IP packets are encrypted by IPsec and then encapsulated by an UDP header, and thereafter the IP packets are transmitted to the in-house LAN.

FIG. 3B shows an example of IP packets passed between the first guest virtual machine 10B and the guest VPN connection interface 44 (at an upper module), and IP packets passed from the computer 10 to the in-house LAN (at a lower module). IP packets passed between the application 15 and the host VPN connection interface 43 and IP packets passed from the computer 10 to the in-house LAN are also similar to the above example.

As shown in FIG. 3B, packets transmitted from the first guest virtual machine 10B and the host application are encrypted, and IPsec packets having a public IP header as a tunneling IP address are generated. Then, the IPsec packets are encapsulated by a dummy UDP header. The dummy UDP header is determined by negotiation of a port number and information of an ESP header used by a UDP header by the IPsec NAT traversal extension technique when the first guest virtual machine 10B and the host application carry out key exchange of IPsec with a communication destination in addition, the virtual network management module 41 has a function of notifying a port number and ESP header information used for the determined dummy UDP header to the receiving packet allocation processing module 45. In this manner, whether the transmission source and the destination are any of the first guest virtual machine 10B and the application 15 can be identified. Then, a public ID header including a public IP address that is same as that of the second guest virtual machine 10C as a transmission source IP address is added to a front of data encapsulated by the UDP header, and in this manner the packets are converted to packets in the IPsec NAT traversal format.

In the above description, the virtual network software 40 allocates private IP addresses of applications of the first guest virtual machine 10B and the host virtual machine 10A. Such private IP addresses may be static IP addresses, or may be dynamically allocated from several candidates. Also, the private IP addresses may not be allocated by the virtual network software 40, but may be dynamically allocated by the DHCP server connected by VPN.

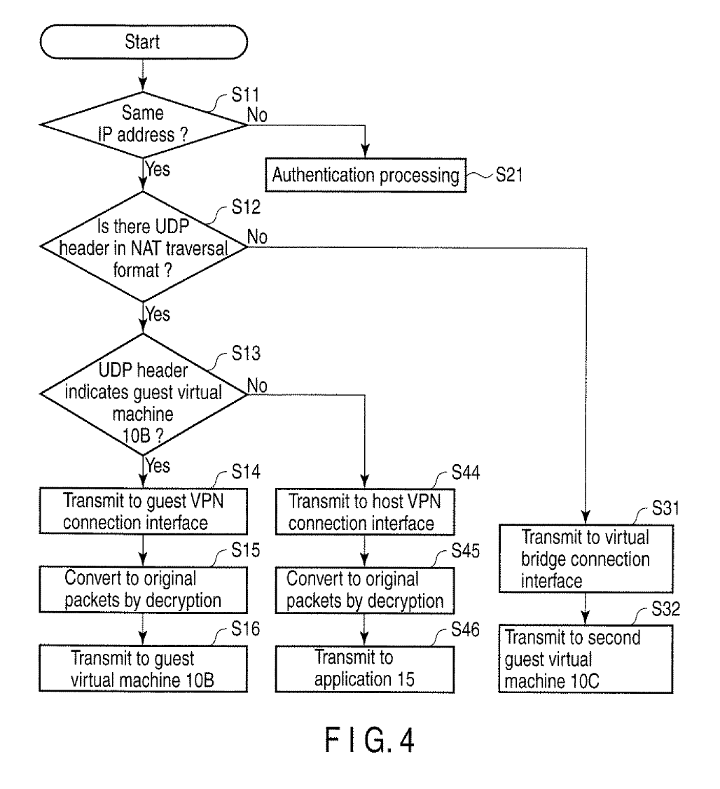

Next, with reference to a flowchart in FIG. 4, description will be made with respect to steps of packet processing at the time of receiving.

When the physical network interface card 18 receives packets from the in-house LAN, the packets are sent to the receiving packet allocation processing module 45. The receiving packet allocation processing module 45 first determines whether the packets will be discarded or forwarded by referring to a public IP address (Block S11). That is, if an IP address of a header of the received packets is the same as an IP address allocated by the DHCP server 30, the packets are forwarded. If the IP addresses are different from the IP address, the packets are discarded (Block S21).

Next, the receiving packet allocation processing module 45 determines whether a dummy UDP header (in the IPsec NAT traversal format) exists or not (Block S12). If there is no dummy UDP packet (NO in Block S12), the receiving packet allocation processing module 45 determines that the packets are addressed to the second quest virtual machine 10C, and the receiving packet allocation processing module 45 transmits the packets to the virtual bridge connection interface 42 (Block S31). The virtual bridge connection interface 42 transmits the received packets to the second guest virtual machine 10C as they are (Block S32).

In the case where the receiving packet allocation processing module 45 determines that there is a dummy UDP header (YES in Block S12), the receiving packet allocation processing module 45 discriminates whether the UDP header is allocated to the second guest virtual machine 10C or not (Block S13).

If the UDP header is determined to be allocated to the first guest virtual machine 10B (YES in Block S13), the receiving packet allocation processing module 45 transmits the received packets to the guest VPN connection interface 44 (Block S14). The guest VPN connection interface 44 converts the packets to original packets to be transmitted to the first guest virtual machine 10B (Block S15). That is, after removing the public IP header, the UDP header, an ESP/IP header, and ESP authentication data from the received packets, the guest VPN connection interface 44 carries out decoding for removing encryption. Then, the guest VPN connection interface 44 removes an ESP trailer included in the decoded data. Thereafter, the guest VPN connection interface 44 transmits the converted packets to the first guest virtual machine 10B.

If the dummy UDP header is determined to be allocated to the host virtual machine 10A in Block S13 (NO in Block S13), the receiving packet allocation processing module 45 transmits the received packets to the host VPN connection interface 43 (Block S44). The host VPN connection interface 43 converts the packets to original packets to be transmitted to the application 15 (Block S45). That is, after removing the public IP header, the UDP header, an ESP/IP header, and ESP authentication data from the received packets, the host VPN connection interface 43 carries out decoding for removing encryption. Then, the host VPN connection interface 43 removes an ESP trailer included in the decoded data. Thereafter, the host VPN connection interface 43 transmits the converted packets to the application 15.

In the above processing, data received from the in-house LAN can be transmitted to a corresponding destination.

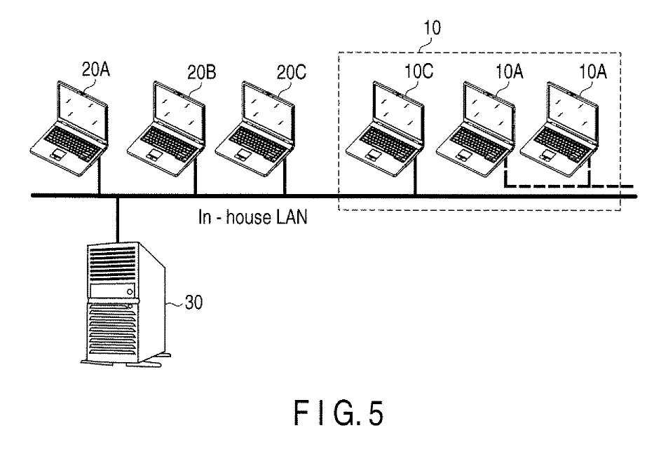

FIG. 5 shows a logical configuration view in the case where the computers 10 equipped with the virtual network software described above and computers 20A to 20C are connected to the same in-house LAN. As shown in FIG. 5, packets on the network are transmitted and received as though the second guest virtual machine 10C is connected to the same in-house LAN of the normal computers 20A to 20C by bridge connection. In addition, packets are transmitted and received as though the first guest virtual machine 10B and the host virtual machine 10A are connected by VPN.

When virtual network software that is realized by a conventional virtualization software system is used, and a virtual machine is connected to the outside, any of 1. bridge mode, 2. NAT mode, and 3. router mode needs to be selected for each physical network interface. Also, in order to have the logical configuration as shown in FIG. 5, a computer needs to include two physical network interfaces, which are a physical network interface used for connection with the in-house LAN and a physical network interface for VPN. However, according to the computer 10, only one physical network interface card 18 needs to be included.

According to the present invention, as shown in FIG. 5, advantageous effects as described below can be obtained in a system where a computer executing a plurality of virtual machines and a computer not executing a virtual machine are connected to an in-house LAN in a co-existing manner.

1. The number of public IP addresses allocated to a computer that executes virtual machines is reduced.

2. Restriction on applications used by a client PC is reduced.

3. A computer system and a virtual network system that can allow commonality of a system of IP addresses that are allocated to a computer used for general operations and a virtual machine is provided.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device where a host virtual machine and N guest virtual machines are allocated to a plurality of logically divided computing resources and operating systems run in the host virtual machine and the N guest virtual machines concurrently, respectively, and the information processing device is connected to a network by a network interface, wherein
the host virtual machine comprises:
a virtual bridge connection module configured to virtually connect one guest virtual machine selected from the N guest virtual machines and the network by bridge connection;
a conversion modules provided in association with the N−1 guest virtual machines not connected to the network virtually by bridge connection and an application that runs on the host virtual machine, and configure to convert packets transmitted from the N−1 guest virtual machines and the application that runs on the host virtual machine to packets of a virtual private network (VPN) protocol; and
a packet allocation module configured to detect a destination of the packets received from the network, to allocate the received packets to the virtual bridge connection module in a case where the detected destination is the one guest virtual machine, and to convert the packets of the VPN protocol received from the network to original packets and to allocate the converted packets to the detected destination in a case where the detected destination is any of the N−1 guest virtual machines and the application that runs on the host virtual machine.

2. The information processing device according to claim 1, further comprising a MAC address allocation module configure to allocate a MAC address of the network interface to the one guest virtual machine.

3. The information processing device according to claim 1, wherein the conversion to the packets of the VPN protocol is carried out by using an IPsec NAT traversal technique.

4. The information processing device according to claim 3, wherein
the packet allocation module determines that a destination of packets without an UDP header in an IPsec NAT traversal format is the one guest virtual machine, and a destination of packets including the UDP header is any of the N−1 guest virtual machines and the application that runs on the host virtual machine in accordance with the UDP header.

5. The information processing device according to claim 1, wherein
the host virtual machine monitors packets transmitted and received between the one guest virtual machine and a DHCP server connected to the network to detect an IP address that is allocated to the one guest virtual machine by the DHCP server, and
the conversion module sets the IP address to an IP header of the packets of the VPN protocol.

6. A communication control method of an information processing device where a host virtual machine and N guest virtual machines are allocated to a plurality of logically divided computing resources and operating systems run in the host virtual machine and the N guest virtual machines concurrently, respectively, and the information processing device is connected to a network by a network interface, the method comprising:
carrying out communication between one guest virtual machine selected from the N guest virtual machines and the network by virtual bridge connection;
converting packets transmitted from the N−1 guest virtual machines and the application that runs on the host virtual machine to packets of a virtual private network (VPN) protocol;
detecting a destination of the packets received from the network;
allocating the received packets to the virtual bridge connection means in a case where the detected destination is the one guest virtual machine;
converting the packets of the VPN protocol received from the network to original packets in a case where the detected destination is any of the N−1 guest virtual machines and the application that runs on the host virtual machine; and
allocating the converted packets to the detected destination.

7. The communication control method according to claim 6, further comprising allocating a MAC address of the network interface to the one guest virtual machine.

8. The communication control method according to claim 6, wherein the conversion to the packets of the VPN protocol is carried out by using an IPsec NAT traversal technique.

9. The communication control method according to claim 8, wherein
the detecting determines that a destination of packets without an UDP header in an IPsec NAT traversal format is the one guest virtual machine, and a destination of packets including the UDP header is any of the N−1 guest virtual machines and the application that runs on the host virtual machine in accordance with the UDP header.

10. The communication control method according to claim 6, further comprising monitoring packets transmitted and received between the one guest virtual machine and a DHCP server connected to the network to detect an IP address that is allocated to the one guest virtual machine by the DHCP server, and
the conversion means sets the IP address to an IP header of the packets of the VPN protocol.
